(19) United States
(12) Patent Application Publication
(10) Pub. No.: US 2010/0058597 A1
(43) Pub. Date: Mar. 11, 2010

(54) SAW BLADE GUARD UNIT

(75) Inventors: Aldous CHAO, Nantou City (TW); David Wang, Tainan City (TW); Sammy Chan, Tainan City (TW)

Correspondence Address: BROWDY AND NEIMARK, P.L.L.C.;624 NINTH STREET, NW, SUITE 300, WASHINGTON, DC, 20001-5303, US

(73) Assignee: K&W Tools, Co., Ltd., Nantou City (TW)

(21) Appl. No.: 12/499,953

(22) Filed: Jul. 9, 2009

(30) Foreign Application Priority Data
Sep. 11, 2008 (TW) 97134894

(51) Int. Cl. B26B 29/00

(52) U.S. Cl. 30/286; 30/514; 30/504

(57) ABSTRACT

A saw blade guard unit is used in cooperation with a handsaw having a saw blade and a handle connected with the saw blade. The saw blade guard unit includes a flexible strip and a holder. The flexible strip has a head end, a tail end for positioning to a front portion of the saw blade of the handsaw, and a body between the head end and the tail end for guarding teeth of the saw blade of the handsaw. The holder is adapted for mounting to the handle of the handsaw. The holder is connected with the head end of the flexible strip and capable of rolling up the flexible strip

### BACKGROUND OF THE INVENTION

1. Field of the Invention

The present invention relates generally to sawing tools and more specifically, to a saw blade guard unit for use in cooperation with a handsaw, which can be rolled up and received in a casing at the handle of the handsaw, or pulled out of the casing to guard the teeth of the saw blade when the handsaw is not in use.

2. Description of the Related Art

Upon receiving or transporting a handsaw, the teeth of the saw blade must be covered with a strip-like guard to protect the teeth of the saw blade against accidental damage, maintaining normal functioning of the handsaw. A strip-like guard for this purpose is usually designed as an individual member separating from the handsaw, A user must keep the strip-like guard in the nearby place so that the strip-like guard can be quickly picked up for use when desired. However, because the strip-like guard is an individual member, it will get lost very easily.

### SUMMARY OF THE INVENTION

The present invention has been accomplished in view of the above-noted circumstances. It is therefore an objective of the present invention to provide a saw blade guard unit, which can be mounted in the handle of a handsaw and can be alternatively set between a received position kept from sight or an extended position to guard the teeth of the saw blade of the handsaw.

To achieve this objective of the present invention, the saw blade guard unit, which is used in cooperation with a handsaw having a saw blade and a handle connected with the saw blade, comprises a flexible strip and a holder. The flexible strip has a head end, a tail end for positioning to a front portion of the saw blade of the handsaw, and a body between the head end and the tail end for guarding teeth of the saw blade of the handsaw. The holder is adapted for mounting to the handle of the handsaw. The holder is connected with the head end of the flexible strip and capable of rolling up the flexible strip. When the handsaw is not in use, the user can pull the tail end of the flexible strip outwardly and then fasten it to a front portion of the saw blade to have the teeth of the saw blade be guarded by the body of the flexible strip. When a user wants to use the handsaw, the user can disconnect the tail end of the flexible strip from the front portion of the saw blade for enabling the flexible strip to be rolled up by the holder.

In an exemplary embodiment of the present invention, the saw blade guard unit may further comprise a guide roller adapted for mounting to a bottom of the handle of the handsaw for guiding forward and backward movements of the flexible strip along the saw blade of the handsaw.

In an exemplary embodiment of the present invention, the holder is adapted for mounting in a casing of the handle of the handsaw. The holder has a reversible reel for rolling up the flexible strip. The reversible reel has a hook connected with the head end of the flexible strip.

In an exemplary embodiment of the present invention, the head end of the flexible strip may have a through hole into which the hook of the reversible reel of the holder hooks.

In an exemplary embodiment of the present invention, the tail end of the flexible strip may have an opening with which a retaining plate is engaged. The retaining plate has a positioning pin for fastening to the front portion of the saw blade of the handsaw.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given herein below and the accompanying drawings which are given by way of illustration only, and thus are not limitative of the present invention, and wherein:

FIG. 1 is a perspective view of a handsaw equipped with a saw blade guard unit in accordance with an exemplary embodiment of the present invention;

FIG. 2 is a front view of the handsaw of FIG. 1;

FIG. 3 is an exploded view of the saw blade guard unit and the handle of the handsaw shown in FIG. 1; and

FIG. 4 is a schematic drawing illustrating that the saw blade guard unit is in use.

### DETAILED DESCRIPTION OF THE INVENTION

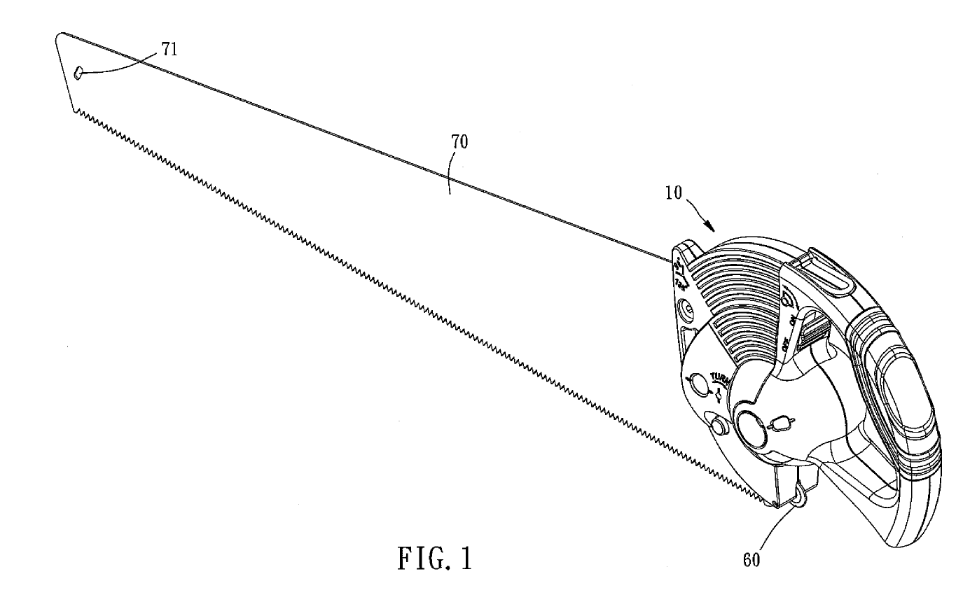

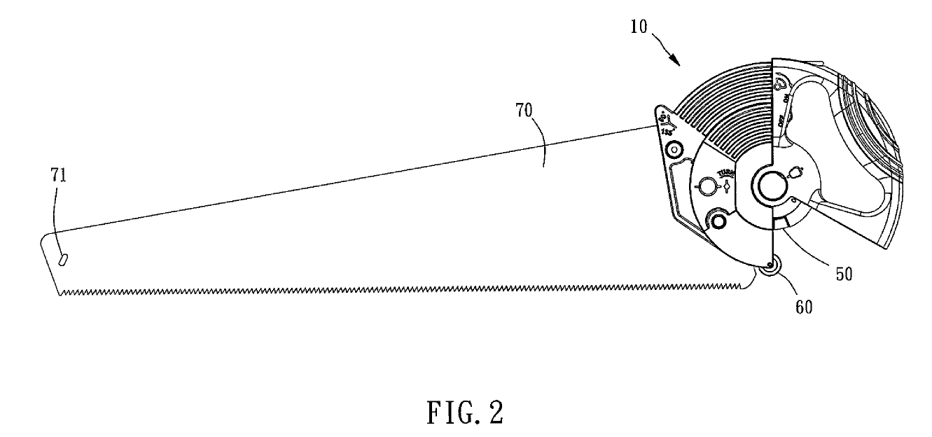

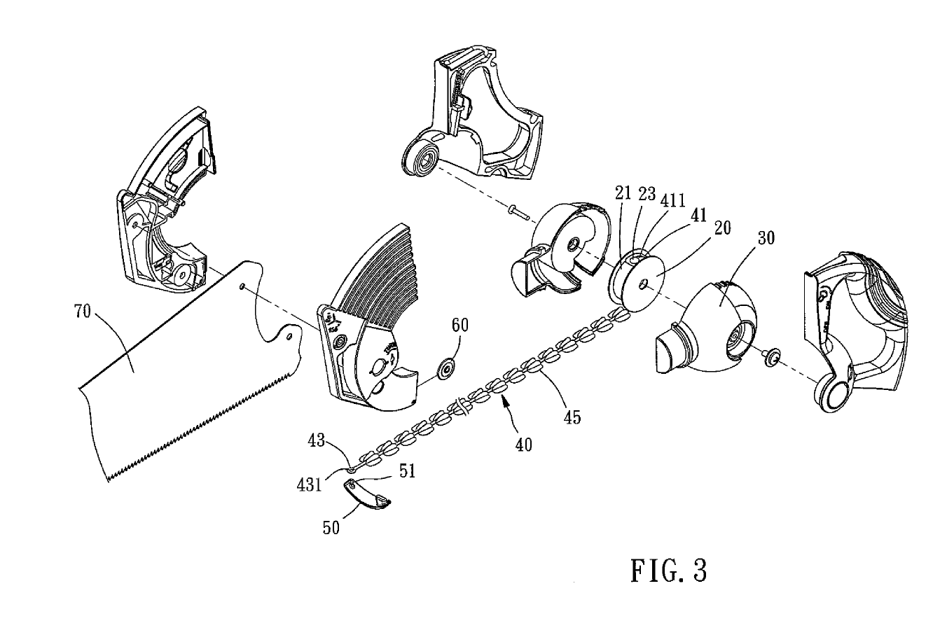

As shown in FIGS. 1-3, a saw blade guard unit in accordance with an exemplary embodiment of the present invention is used to be mounted in a handle 10 of a handsaw. The saw blade guard unit comprises a holder 20, which is mounted inside a casing 30 at the handle 10 and has an auto-reversible reel 21 that has a hook 23, a flexible strip 40, and a guide roller 60. The flexible strip 40 is rolled up on the auto-reversible reel 21 at a normal status when the handsaw is in use and extendable out of the casing 30 for guarding the teeth of the saw blade 70 of the handsaw. The flexible strip 40 has a head end 41 that has a through hole 411 for insertion by the hook 23 of the auto-reversible reel 21, a tail end 43 that has an opening 431, and a body 45 disposed between the head end 41 and the tail end 43, a retaining plate 50 connected to the opening 431 of the tail end 43 and provided with a positioning pin 51 for detachably fastening to a front locating hole 71 at a front portion of the saw blade 70, such that the teeth of the saw blade 70 can be surrounded by the body 45 of the flexible strip 40. The guide roller 60 is rotatably mounted on the bottom of the handle 10 of the handsaw for guiding forward and backward movements of the body 45 of the flexible strip 40 along the extending direction of the blade 70.

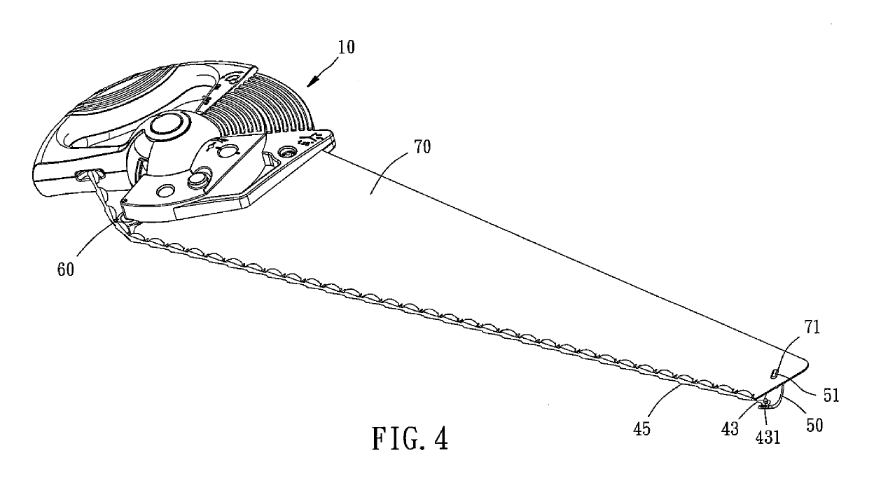

As shown in FIG. 4, when the flexible strip 40 is pulled out of the casing 30 of the handsaw and the positioning pin 51 of the flexible strip 40 is fastened to the front locating hole 71 at the front portion of the saw blade 70, the body 45 of the flexible strip 40 can cover the teeth of the blade 70 so as to protect the teeth of the blade 70. On the other hand, when a user wants to cut a workpiece with the handsaw, the user can disconnect the positioning pin 51 that is fastened to the front locating hole 71 at the front portion of the saw blade 70 to enable the auto-reversible reel 21 to automatically roll up the flexible strip 40.

Although a particular embodiment of the invention has been described in detail for purposes of illustration, various modifications and enhancements may be made without departing from the spirit and scope of the invention. For example, the saw blade guard unit can be installed on the outside wall of the handle, or detachably attached to the handle of the handsaw. Accordingly, the invention is not to be limited except as by the appended claims.

What is claimed is:

1. A saw blade guard unit for use in cooperation with a handsaw having a saw blade and a handle connected with the saw blade, said saw blade guard unit comprising:
a flexible strip having a head end, a tail end for positioning to a front portion of the saw blade of the handsaw, and a body between the head end and the tail end for guarding teeth of the saw blade of the handsaw; and
a holder for mounting to the handle of the handsaw, the holder being connected with the head end of the flexible strip and capable of rolling up the flexible strip.

2. The saw blade guard unit as claimed in claim 1, further comprising a guide roller adapted for mounting to a bottom of the handle of the handsaw for guiding forward and backward movements of the flexible strip along the saw blade of the handsaw.

3. The saw blade guard unit as claimed in claim 1, wherein the holder is adapted for mounting in a casing of the handle of the handsaw and has a reversible reel for rolling up the flexible strip; wherein the reversible reel has a hook connected with the head end of the flexible strip.

4. The saw blade guard unit as claimed in claim 3, wherein the head end of the flexible strip is provided with a through hole into which the hook of the reversible reel of the holder hooks.

5. The saw bladed guard unit as claimed in claim 1, wherein the tail end of the flexible strip has an opening with which a retaining plate is engaged; wherein the retaining plate has a positioning pin for fastening to the front portion of the saw blade of the handsaw.

6. The saw blade guard unit as claimed in claim 1, wherein the tail end of the flexible strip is adapted for positioning to a locating hole provided at the front portion of the saw blade of the handsaw.
